(19) United States
(12) Patent Application Publication
(10) Pub. No.: US 2012/0155465 A1
(43) Pub. Date: Jun. 21, 2012

(54) RECEPTION STATION FOR RECEIVING DATA FROM TRANSMISSION STATION, TRANSMISSION STATION FOR TRANSMITTING DATA, AND METHOD FOR OPERATING RECEPTION STATION

(75) Inventors: Kye Seon LEE, Daejeon (KR); Jong Arm JUN, Daejeon (KR)

(73) Assignee: Electronics and Telecommunications Research Institute, Daejeon (KR)

(21) Appl. No.: 13/332,083

(22) Filed: Dec. 20, 2011

(30) Foreign Application Priority Data
Dec. 20, 2010 (KR) 10-2010-0130694

(51) Int. Cl. H04L 12/56

(52) U.S. Cl. 370/390

(57) ABSTRACT

A reception station and a method for operating the reception station that may receive data using a multicast address from a transmission station are provided. The reception station may include an interface to receive a data packet including a multicast address from a transmission station, and a processor to distinguish a group address and a service address from the multicast address, and to maintain a reception of the data packet when a group address and a service address that are respectively identical to the distinguished group address and the distinguished service address are found from a database.

### CROSS-REFERENCE TO RELATED APPLICATIONS

This application claims the benefit of Korean Patent Application No. 10-2010-0130694, filed on Dec. 20, 2010, in the Korean Intellectual Property Office, the disclosures of which are incorporated herein by reference.

### BACKGROUND

1. Field of the Invention

The present invention relates to a reception station and a method for operating the reception station that may receive data using a multicast address from a transmission station.

2. Description of the Related Art

A data transmission scheme is classified into a unicast scheme for one-to-one communication, and a broadcast scheme and a multicast scheme that are used for one-to-many communication. The broadcast scheme may enable a single sender to transmit the same data to unspecified receivers. The multicast scheme may enable a single sender to transmit the same data to certified receivers, for example members of a specific group.

To form a group in the multicast scheme, a leader of a group needs to broadcast group information, and a receiver desiring to become a member of the group needs to go through procedures to join the group. However, the multicast scheme does not provide a scheme of changing a list of receivers and transmitting the changed list depending on circumstances, after the group is formed.

To transmit data to specific receivers in the group, rather than all members of the group after the group is formed, the unicast scheme may be used for the specific receivers in the group, or the multicast scheme may be used for a group that is re-formed of the specific receivers. However, traffic unnecessary for a network may occur. Accordingly, there is a desire for a technology that may effectively and simply transmit data to specific receivers in a group.

### SUMMARY

An aspect of the present invention provides a reception station and a method for operating the reception station that may receive a data packet including a multicast address from a transmission station, and may maintain a reception of the data packet when a group address and a service address that are included in the multicast address are respectively identical to a group address and a service address that are stored in the reception station, and thus it is possible to enable only a specific reception station in a group to normally receive a data packet from a transmission station.

According to an aspect of the present invention, there is provided a reception station, including: an interface to receive a data packet from a transmission station, the data packet including a multicast address; and a processor to distinguish a group address and a service address from the multicast address, to search for, from a database, a group address and a service address that are respectively identical to the distinguished group address and the distinguished service address, and to maintain a reception of the data packet when the group address and the service address that are respectively identical to the distinguished group address and the distinguished service address are found.

According to another aspect of the present invention, there is provided a method for operating a reception station, including: receiving a data packet from a transmission station, the data packet including a multicast address; distinguishing a group address and a service address from the multicast address; and searching for, from a database, a group address and a service address that are respectively identical to the distinguished group address and the distinguished service address, and maintaining or interrupting a reception of the data packet based on a result of the searching.

### Effect

According to embodiments of the present invention, a reception station may receive a data packet including a multicast address from a transmission station, and may maintain a reception of the data packet when a group address and a service address that are included in the multicast address are respectively identical to a group address and a service address that are stored in the reception station. Thus, it is possible to enable only a specific reception station in a group to normally receive a data packet from a transmission station.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a reception station according to an embodiment of the present invention;

FIG. 2 is a diagram illustrating cast information and a multicast address that are received by a reception station according to an embodiment of the present invention;

FIG. 3 is a diagram illustrating a method for receiving a data packet based on a service supported by a reception station according to an embodiment of the present invention; and

FIG. 4 is a flowchart illustrating a method for operating a reception station according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

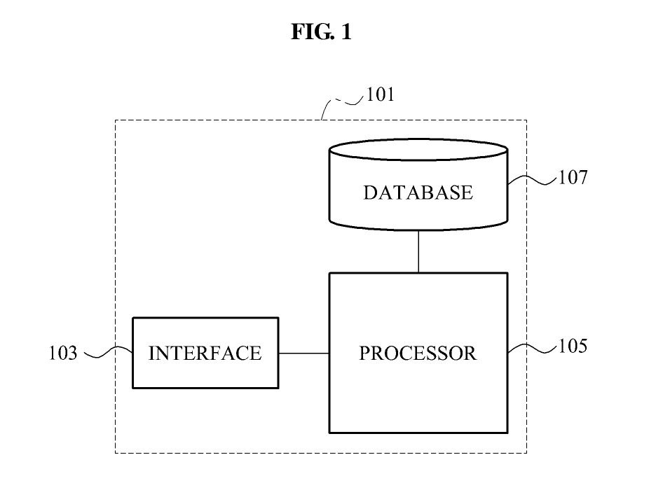

FIG. 1 is a diagram illustrating a configuration of a reception station 101 according to an embodiment of the present invention.

Referring to FIG. 1, the reception station 101 may include an interface 103, a processor 105, and a database 107.

The interface 103 may receive a data packet including a multicast address from a transmission station. Here, the multicast address may include a group address, and a service address. In other words, when the multicast address is defined by N bits, and when the group address is defined by M bits, the service address may be defined by ‘N-M’ bits. Here, N and M are natural numbers. For example, when the multicast address includes 16 bits, and the group address includes 8 bits, the service address may include 8 bits.

Additionally, the data packet may further include cast information. The cast information may be used to determine whether the data packet needs to be transmitted to all reception stations in a group.

The processor 105 may extract the cast information from the data packet.

In an example in which the extracted cast information is associated with transmission of the data packet to a specific reception station in the group, rather than all of the reception stations in the group (for example, when the cast information has a value of ‘0’, or when the cast information indicates that the transmission station desires to transmit the data packet to the specific reception station), the processor 105 may search for, from the database 107, a multicast address identical to the multicast address extracted from the data packet, and may control reception of the data packet based on a result of the searching.

Specifically, the processor 105 may distinguish the group address and the service address from the multicast address, may search for, from the database 107, a group address and a service address that are respectively identical to the distinguished group address and the distinguished service address, and may maintain or interrupt the reception of the data packet based on the result of the searching. When the group address and the service address that are respectively identical to the distinguished group address and the distinguished service address are found from the database 107, the processor 105 may maintain the reception of the data packet. Conversely, when at least one of the group address and the service address is not found from the database 107, the processor 105 may interrupt the reception of the data packet.

In another example in which the extracted cast information is associated with transmission of the data packet to all of the reception stations in the group (for example, when the cast information has a value of ‘1’, or when the cast information indicates that the transmission station desires to transmit the data packet to all of the reception stations), when the group address identical to the distinguished group address is found from the database 107, the processor 105 may maintain the reception of the data packet, regardless of whether the service address identical to the distinguished service address is found. In other words, when the transmission station transmits the data packet to all of the reception stations in the group, the reception station 101 of the group may continue to receive the data packet from the transmission station, regardless of a service supported by the reception station 101.

The database 107 may store a group address and a service address. The group address may correspond to a group to which the reception station 101 belongs, and the service address may correspond to a service supported by the reception station 101. The reception station 101 may support various services, and accordingly the database 107 may store a plurality of distinguished service addresses.

The transmission station may be a counter communication part of the reception station 101. The transmission station may allocate N bits to the group address and the service address of the multicast address defined by the N bits, and may transmit a data packet including the multicast address to the reception station 101.

To define the multicast address with the N bits, the transmission station may allocate M bits among the N bits to the group address, and may allocate remaining bits obtained by subtracting the M bits from the N bits to the service address. Here, both N and M are natural numbers.

Additionally, the transmission station may form the data packet that further includes cast information used to determine whether the data packet needs to be transmitted to all reception stations in a group or to a predetermined reception station in the group.

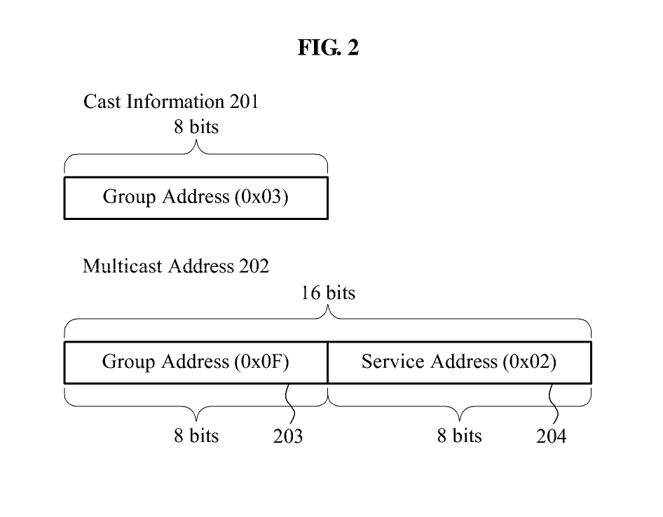

FIG. 2 is a diagram illustrating cast information and a multicast address that are received by a reception station according to an embodiment of the present invention.

Referring to FIG. 2, the reception station may receive a data packet from a transmission station, and may extract, from the data packet, cast information 201, and a multicast address 202.

For example, when the cast information 201 corresponds to ‘0x03’, the reception station may verify that the transmission station transmits the data packet to a specific reception station in a group, and may compare the extracted multicast address 202 with a multicast address stored in a database of the reception station.

In this example, when a group address and service address in the multicast address stored in the database respectively correspond to ‘0x0F’ and ‘0x02’, the reception station may maintain reception of the data packet. Conversely, when the group address and service address in the multicast address stored in the database do not correspond to ‘0x0F’ and ‘0x02’, the reception station may interrupt the reception of the data packet.

In other words, only a reception station including a group address of ‘0x0F’ and a service address of ‘0x02’ may continue to receive a data packet from a transmission station. Accordingly, the transmission station may transmit the data packet to a reception station that is included in a group corresponding to the group address of ‘0x0F’ and that supports a service corresponding to the service address of ‘0x02’, and may transfer a command to the reception station.

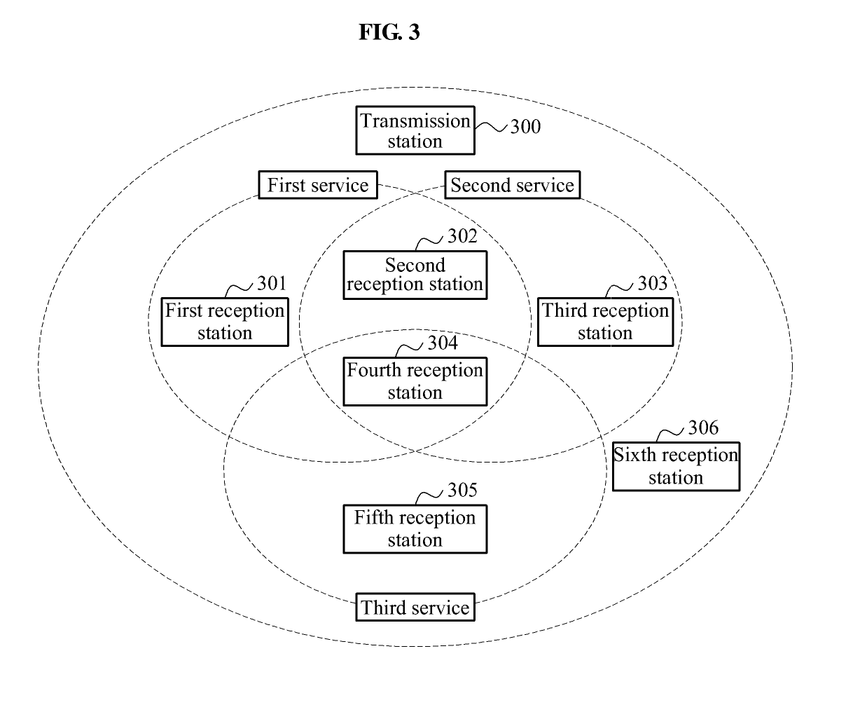

FIG. 3 is a diagram illustrating a method for receiving a data packet based on a service supported by a reception station according to an embodiment of the present invention.

Referring to FIG. 3, a first reception station 301, a second reception station 302, a third reception station 303, a fourth reception station 304, a fifth reception station 305, and a sixth reception station 306 may be included in a single group. The first reception station 301, the second reception station 302, and the fourth reception station 304 may support a first service. The second reception station 302, the third reception station 303, and the fourth reception station 304 may support a second service. Additionally, the fourth reception station 304 and the fifth reception station 305 may support a third service, and the sixth reception station 306 may not a service.

The first reception station 301 through the sixth reception station 306 may each extract cast information from a data packet that is received from a transmission station 300.

In an example in which the extracted cast information is associated with transmission of the data packet to a specific reception station in the group, the first reception station 301 through the sixth reception station 306 may control reception of the data packet, based on a service type supported by each of the first reception station 301 through the sixth reception station 306. In this example, the first reception station 301 through the sixth reception station 306 may be assumed to be included in a group corresponding to a group address in the data packet.

Specifically, the first reception station 301 may support the first service. Accordingly, when a service address in the data packet received from the transmission station 300 corresponds to ‘0x01’, the first reception station 301 may maintain the reception of the data packet. Conversely, when the service address does not correspond to ‘0x01’, the first reception station 301 may interrupt the reception of the data packet.

Additionally, the second reception station 302 may support the first service and the second service. Accordingly, when the service address in the data packet received from the transmission station 300 corresponds to ‘0x01’ or ‘0x02’, the second reception station 302 may maintain the reception of the data packet.

The third reception station 303 may support the second service. Accordingly, when the service address in the data packet received from the transmission station 300 corresponds to ‘0x02’, the third reception station 303 may maintain the reception of the data packet.

The fourth reception station 304 may support the first service, the second service, and the third service. Accordingly, when the service address in the data packet received from the transmission station 300 corresponds to ‘0x01’, ‘0x02’, or ‘0x03’, the fourth reception station 304 may maintain the reception of the data packet.

The fifth reception station 305 may support the third service. Accordingly when the service address in the data packet received from the transmission station 300 corresponds to ‘0x03’, the fifth reception station 305 may maintain the reception of the data packet.

Since no service is supported by the sixth reception station 306, the sixth reception station 306 may interrupt reception of the data packet, regardless of the service address in the data packet transmitted from the transmission station 300.

In another example in which the extracted cast information is associated with transmission of the data packet to all reception stations in the group, the first reception station 301 through the sixth reception station 306 may maintain reception of the data packet.

For example, when the transmission station 300 controls an internal environment, and when the first reception station 301 through the sixth reception station 306 are included in a group ‘room internal environment’, the transmission station 300 may transmit a data packet including information regarding the group ‘room internal environment’ and information regarding a service ‘window operator’, to ventilate a room. Accordingly, only the first reception station 301, the second reception station 302, and the fourth reception station 304 that correspond to the information regarding the service ‘window operator’ may continue to receive the data packet, so that a window may be opened or closed.

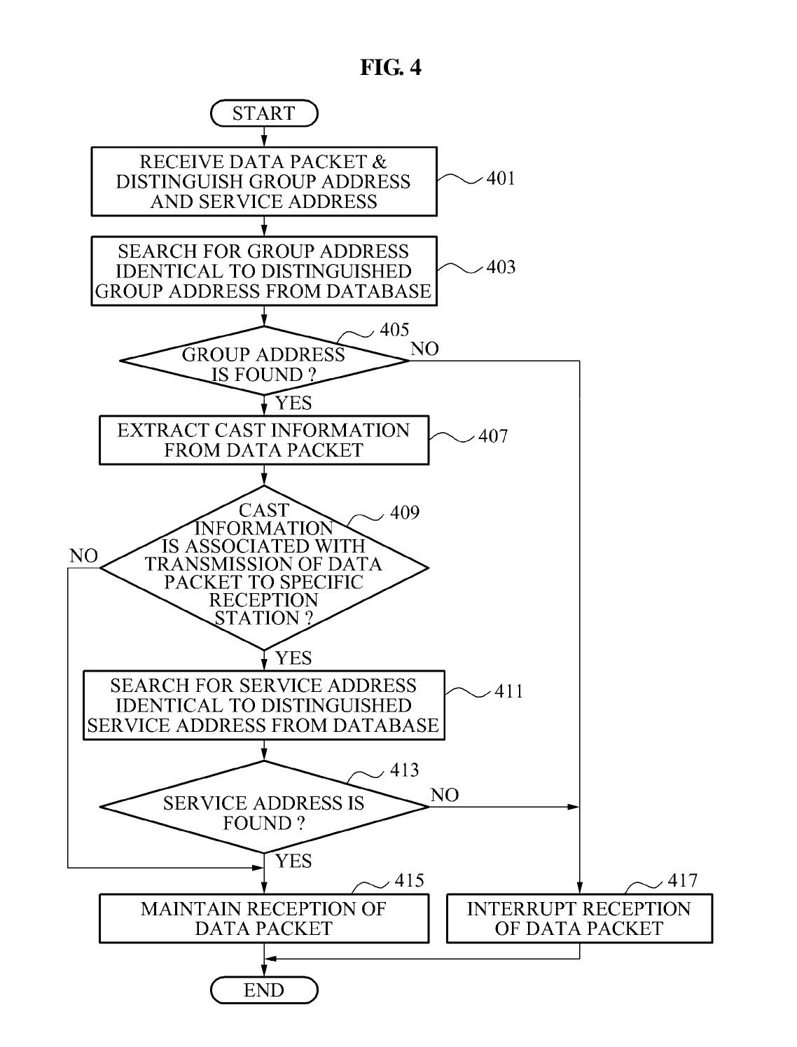

FIG. 4 is a flowchart illustrating a method for operating a reception station according to an embodiment of the present invention.

Referring to FIG. 4, in operation 401, the reception station may receive a data packet including a multicast address from a transmission station, and may distinguish a group address and a service address from the multicast address.

In operation 403, the reception station may search for, from a database, a group address that is identical to the distinguished group address. Specifically, the reception station may compare the distinguished group address with the group address stored in the database, and may determine whether the distinguished group address is identical to the group address stored in the database. The group address stored in the database may correspond to a group to which the reception station belongs.

As a result of operation 403, when the group address is found in operation 405, the reception station may extract cast information from the data packet in operation 407, to check the extracted cast information.

When the extracted cast information is associated with transmission of the data packet to a specific reception station in a group in operation 409, the reception station may search for, from the database, a service address that is identical to the distinguished service address in operation 411. Specifically, the reception station may compare the distinguished service address with the service address stored in the database, and may determine whether the distinguished service address is identical to the service address stored in the database. The service address stored in the database may correspond to a service supported by the reception station.

Conversely, when the extracted cast information is associated with transmission of the data to all reception stations in the group, rather than a specific reception station in the group in operation 409, the reception station may proceed to operation 415.

As a result of operation 411, when the service address is found in operation 413, the reception station may maintain the reception of the data packet from the transmission station in operation 415.

When the group address is not found in operation 405, or when the service address is not found in operation 413, the reception station may interrupt the reception of the data packet from the transmission station in operation 417.

According to embodiments of the present invention, a reception station may receive a data packet including a multicast address from a transmission station, and may maintain reception of the data packet when a group address and a service address that are included in the multicast address are respectively identical to a group address and a service address that are stored in the reception station. Thus, it is possible to enable only a specific reception station in a group to normally receive a data packet from a transmission station.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A reception station, comprising:
an interface to receive a data packet from a transmission station, the data packet comprising a multicast address; and
a processor to distinguish a group address and a service address from the multicast address, and to maintain a reception of the data packet when a group address and a service address that are respectively identical to the distinguished group address and the distinguished service address are found from a database.

2. The reception station of claim 1, wherein, when at least one of the group address and the service address that are respectively identical to the distinguished group address and the distinguished service address is not found from the database, the processor interrupts the reception of the data packet.

3. The reception station of claim 1, wherein, when cast information is extracted from the data packet and when the extracted cast information is associated with a transmission of the data packet to a specific reception station in a group, the processor searches for, from the database, the group address and the service address that are respectively identical to the distinguished group address and the distinguished service address.

4. The reception station of claim 1, wherein, when cast information is extracted from the data packet and when the extracted cast information is associated with a transmission of the data packet to all reception stations in a group, and when the group address identical to the distinguished group address is found from the database, the processor maintains the reception of the data packet, regardless of whether the service address identical to the distinguished service address is found.

5. The reception station of claim 1, wherein the database stores a plurality of distinguished service addresses, based on a service supported by the reception station.

6. A transmission station to allocate N bits to a group address and a service address, wherein N is a natural number, and to transmit a data packet comprising cast information and the multicast address, the group address and the service address being included in the multicast address, the multicast address being defined by the N bits, and the cast information being used to determine whether the transmission station is to transmit data packet to all reception stations in a group.

7. The transmission station of claim 6, wherein M bits among the N bits are allocated to the group address, and remaining bits obtained by subtracting the M bits from the N bits are allocated to the service address, wherein M is a natural number.

8. A method for operating a reception station, the method comprising:
receiving a data packet from a transmission station, the data packet comprising a multicast address;
distinguishing a group address and a service address from the multicast address; and
searching for, from a database, a group address and a service address that are respectively identical to the distinguished group address and the distinguished service address, and maintaining or interrupting a reception of the data packet based on a result of the searching.

9. The method of claim 8, wherein the searching comprises:
maintaining the reception of the data packet when the group address and the service address that are respectively identical to the distinguished group address and the distinguished service address are found from the database; and
interrupting the reception of the data packet when at least one of the group address and the service address that are respectively identical to the distinguished group address and the distinguished service address is not found from the database.

10. The method of claim 8, further comprising:
extracting cast information from the data packet,
wherein the searching comprises, when the extracted cast information is associated with a transmission of the data packet to a specific reception station in a group, maintaining or interrupting the reception of the data packet.

11. The method of claim 8, further comprising:
extracting cast information from the data packet,
wherein the searching comprises, when the extracted cast information is associated with a transmission of the data packet to all reception stations in a group, and when the group address identical to the distinguished group address is found from the database, maintaining the reception of the data packet, regardless of whether the service address identical to the distinguished service address is found.

12. The method of claim 8, further comprising:
storing, in the database, a plurality of distinguished service addresses, based on a service supported by the reception station.
